(19) United States
(12) Patent Application Publication
(10) Pub. No.: US 2012/0315349 A1
(43) Pub. Date: Dec. 13, 2012

(54) TEMPLATE, TEMPLATE MANUFACTURING METHOD, AND TEMPLATE MANUFACTURING APPARATUS

(76) Inventors: Yingkang ZHANG, Kanagawa-ken (JP); Masafumi ASANO, Kanagawa-ken (JP)

(21) Appl. No.: 13/424,879

(22) Filed: Mar. 20, 2012

(30) Foreign Application Priority Data
Jun. 8, 2011 (JP) 2011-128280

(51) Int. Cl. B29C 33/40; B29C 41/52

(52) U.S. Cl. 425/385; 264/227; 425/169; 264/40.1

(57) ABSTRACT

According to one embodiment, a template includes: a base substrate; and a pattern portion provided on the base substrate and including a concave-convex pattern formed from a master pattern. The concave-convex pattern is provided in a distorted state with respect to the master pattern in accordance with a distortion of an underlying pattern formed on a substrate to which a shape of the concave-convex pattern is to be transferred.

### CROSS-REFERENCE TO RELATED APPLICATIONS

This application is based upon and claims the benefit of priority from the prior Japanese Patent Application No. 2011-128280, filed on Jun. 8, 2011; the entire contents of which are incorporated herein by reference.

### FIELD

Embodiments described herein relate generally to a template, a template manufacturing method, and a template manufacturing apparatus.

### BACKGROUND

As a technique for achieving compatibility between fine pattern formation and volume productivity, the so-called nanoimprint method has been drawing attention. The nanoimprint method is a pattern transfer method for transferring the concave-convex pattern of a template to a resin film on a substrate.

In this pattern transfer method, a resin such as a photocurable resin is dropped on the substrate to form a resin film. A template is brought into contact with this resin film. Then, with the resin filled in the concave-convex pattern of the template, the resin is irradiated with e.g. ultraviolet light through the template. Thus, the resin is cured. Subsequently, the template is released. Thus, a pattern having an inverted shape of the concave-convex pattern is formed on the substrate.

In such a pattern transfer method, further improvement in transfer accuracy is required.

### BRIEF DESCRIPTION OF THE DRAWINGS

FIGS. 1A and 1B are schematic views of a template according to a first embodiment;

FIG. 2 is a schematic view showing an example of the template and the underlying pattern;

FIG. 3 is a schematic view showing an example of the template and the underlying pattern;

FIG. 4 is a flow chart illustrating a template manufacturing method according to a second embodiment;

FIGS. 5A to 5C are schematic sectional views showing an example of the template manufacturing method;

FIGS. 6A and 6B are schematic views describing an example of the formation of the concave-convex pattern;

FIG. 7 is a schematic view describing an example template with a concave-convex pattern formed thereon;

FIGS. 8A to 10B are schematic sectional views illustrating a pattern formation method based on an imprint method;

FIGS. 11A to 11D are schematic sectional views showing a template manufacturing method according to a third embodiment;

FIGS. 12A to 12C are schematic sectional views showing a template manufacturing method according to a fourth embodiment;

FIGS. 13A to 13C are schematic sectional views describing an imprinting;

FIGS. 14A and 14B are schematic sectional views illustrating an alternative template manufacturing method;

FIGS. 15A and 15B are block diagrams illustrating a configuration of a template manufacturing apparatus according to a fifth embodiment;

FIGS. 16A and 16B describe a computer on which the program according to the embodiment is executed; and

FIG. 17 is a flow chart illustrating a processing flow of a program according to the embodiment.

### DETAILED DESCRIPTION

In general, according to one embodiment, a template includes: a base substrate; and a pattern portion provided on the base substrate and including a concave-convex pattern formed from a master pattern. The concave-convex pattern is provided in a distorted state with respect to the master pattern in accordance with a distortion of an underlying pattern formed on a substrate to which a shape of the concave-convex pattern is to be transferred.

In general, according to another embodiment, a template manufacturing method includes: acquiring a surface state of a transfer target to which a shape of a concave-convex pattern included in a pattern portion is to be transferred; determining a correction amount for the concave-convex pattern from the surface state; and forming the pattern portion on a base substrate with the concave-convex pattern formed with correction by the correction amount.

In general, according to another embodiment, a template manufacturing apparatus includes: an acquisition section configured to acquire a surface state of a substrate to which a shape of a concave-convex pattern in a pattern portion of a template is to be transferred; a calculation section configured to calculate a correction amount for the concave-convex pattern from the surface state acquired by the acquisition section; and a formation section configured to form the pattern portion on a base substrate with the concave-convex pattern formed with correction by the correction amount calculated by the calculation section.

Embodiments of the invention will now be described with reference to the drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In the present specification and the drawings, components similar to those described previously with reference to earlier figures are labeled with like reference numerals, and the detailed description thereof is omitted appropriately.

### First Embodiment

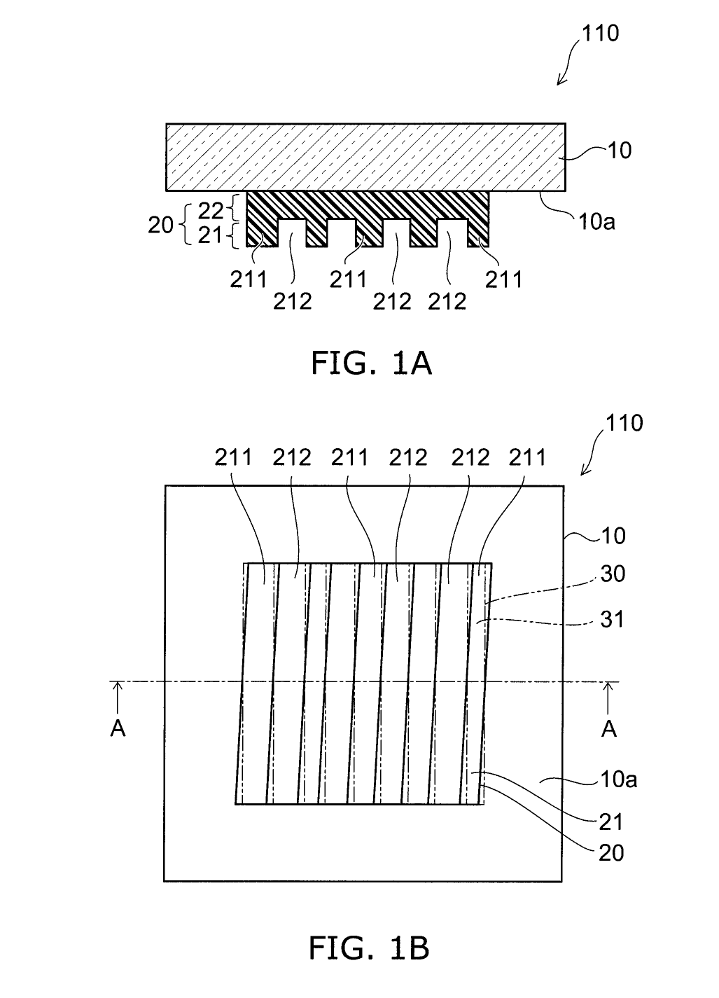

FIGS. 1A and 1B are schematic views illustrating the configuration of a template according to a first embodiment.

FIG. 1A is a schematic sectional view of the template. FIG. 1B is a schematic plan view of the major surface side of the template. FIG. 1A shows a cross section taken along line A-A shown in FIG. 1B.

As shown in FIG. 1A, the template 110 according to the embodiment is used as a plate for transferring a pattern to a transfer target in a pattern transfer method (e.g., the so-called nanoimprint method).

The template 110 includes a base substrate 10 and a pattern portion 20.

The base substrate 10 is a base for supporting the pattern portion 20. In the embodiment, a base substrate 10 having a uniform thickness and a rectangular outline in plan view is used. As the base substrate 10, for instance, a quartz substrate is used.

The pattern portion 20 includes a concave-convex pattern 21 formed from a master pattern 31. The pattern portion 20 includes an intermediate portion 22 provided between the major surface 10a and the concave-convex pattern 21. The intermediate portion 22 only needs to be provided as necessary. In the case of not providing the intermediate portion 22, the concave-convex pattern 21 is directly provided on the major surface 10a. The concave-convex pattern 21 is provided in a distorted state with respect to the master pattern 31 in accordance with the distortion of the underlying pattern formed on the substrate to which the shape of this concave-convex pattern 21 is to be transferred.

Here, the “distortion” referred to in the embodiments includes at least one of the state inclined, the state expanded in at least one direction, and the state contracted in at least one direction, with respect to the reference pattern.

The double dot-dashed line shown in FIG. 1B illustrates the master pattern 31. The master pattern 31 is a reference pattern for forming the concave-convex pattern 21 of the pattern portion 20. In FIG. 1B, the concave-convex pattern 21 is shown by solid lines. For convenience of description, the concave-convex pattern 21 is a line-and-space pattern in which a convex pattern 211 and a concave pattern 212 are repeated. In the embodiment, this concave-convex pattern 21 is provided in a distorted state with respect to the master pattern 31.

In the example shown in FIG. 1B, as an example of distortion, the concave-convex pattern 21 is distorted in an inclined state (like a parallelogram) with respect to a rectangular master pattern 31. The amount of this distortion is matched with the distortion amount of the underlying pattern of the substrate to which the concave-convex pattern 21 is to be transferred by the template 110.

Thus, the concave-convex pattern 21 is formed in accordance with the distortion of the underlying pattern. Accordingly, a new pattern can be accurately transferred onto the underlying pattern formed with distortion. That is, even if the underlying pattern is formed with distortion, a new pattern is accurately transferred onto the underlying pattern in accordance with this distortion.

The pattern portion 20 may be either provided directly on the major surface 10a of the base substrate 10 or provided on the major surface 10a of the base substrate 10 separately from the base substrate 10.

Here, an example method for directly providing a pattern portion 20 on the major surface 10a of the base substrate 10 is described.

First, a hard mask layer (e.g., SiO₂) and a resist layer are formed on the major surface 10a of the base substrate 10.

Next, using the information of the master pattern 31, the resist layer is subjected to e.g. electron beam exposure and development to form a prescribed resist pattern.

Then, the resist pattern is used as a mask to etch the hard mask layer and the base substrate 10.

Accordingly, the portion covered with the resist pattern constitutes a convex pattern 211, and the portion not covered with the resist pattern constitutes a concave pattern 212. Thus, a concave-convex pattern 21 is completed.

In the case of directly providing a concave-convex pattern 21 on the major surface 10a of the base substrate 10, when the resist pattern is formed, the exposure region is corrected in accordance with the distortion of the underlying pattern. For instance, electron beam exposure on the resist layer can be performed with correction to the electron beam irradiation region based on the distortion of the underlying pattern. Thus, the concave-convex pattern 21 is directly formed on the major surface 10a in accordance with the distortion of the underlying pattern.

Next, an example method for separately providing a pattern portion 20 on the major surface 10a of the base substrate 10 is described.

First, a resin layer is formed on the major surface 10a of the base substrate 10.

Next, an original plate 30 with the master pattern 31 formed thereon is prepared. The master pattern 31 of this original plate 30 is brought into contact with the resin layer. The resin of the resin layer is e.g. a photocurable resin or thermosetting resin.

Then, the resin layer in contact with the master pattern 31 is cured by light irradiation or heating. After the resin layer is cured, the original plate 30 is separated.

Accordingly, a concave-convex pattern 21 with the shape of the master pattern 31 transferred to the resin layer is formed.

In the case of separately providing a concave-convex pattern 21 on the major surface 10a of the base substrate 10, when the resin layer in contact with the original plate 30 is cured, for instance, the distortion of a second distortion amount is applied to the base substrate 10. The second distortion amount is the reverse of the distortion amount of the underlying pattern (first distortion amount). In this state, the resin layer is cured. After the resin layer is cured, the original plate 30 is separated. Then, the distortion applied to the base substrate 10 is relieved.

Thus, the concave-convex pattern 21 is formed while the base substrate 10 is distorted. Hence, when the base substrate 10 is relieved from the distortion and returns to the original shape, the concave-convex pattern 21 on the base substrate 10 is distorted oppositely. The concave-convex pattern 21 is distorted by the return of the second distortion amount, i.e., by the first distortion amount.

The method for separately forming a concave-convex pattern 21 on the major surface 10a of the base substrate 10 can form a concave-convex pattern 21 in a shorter time than the directly forming method. Furthermore, reuse of the base substrate 10 is also easy.

In the following, the embodiment is described with reference to an example in which a concave-convex pattern 21 is separately formed on the major surface 10a of the base substrate 10.

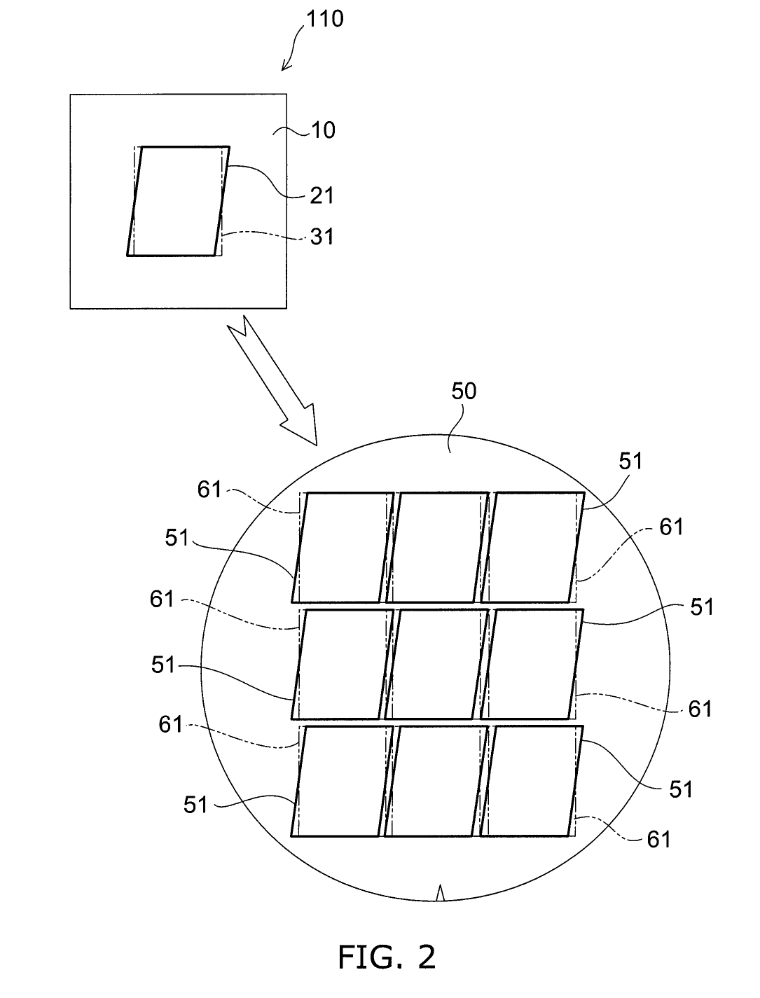

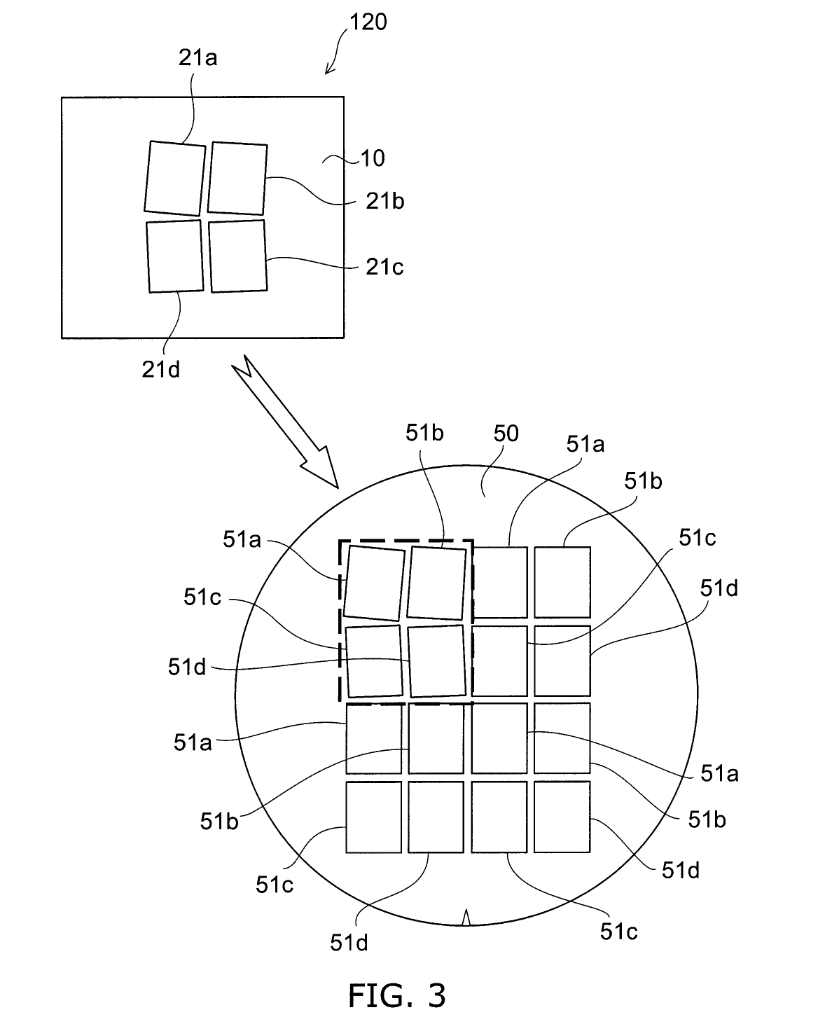

FIGS. 2 and 3 are schematic views showing examples of the template and the underlying pattern.

In FIGS. 2 and 3, for convenience of description, the concave-convex pattern 21, the underlying pattern 51, the master pattern 31, and the design pattern 61 are each shown by a frame representing only the region where the pattern is formed. Here, one frame representing the region of each pattern corresponds to one exposure region (one shot) in forming the underlying pattern 51 by photolithography.

FIG. 2 shows an example in which a region of the concave-convex pattern 21 corresponding to one shot is provided on the base substrate 10.

On the processing substrate 50, the underlying pattern 51 is previously formed. The underlying pattern 51 is formed in the processing substrate 50 or on the surface of the processing substrate 50 by e.g. photolithography and etching. In forming the underlying pattern 51, the shot alignment may deviate from the ideal condition. This deviation is referred to as “alignment error”. In FIG. 2, the double dot-dashed line shown on the processing substrate 50 represents the region of the design pattern 61 formed under the ideal condition. Due to the alignment error, the underlying pattern 51 is formed in a distorted state with respect to the design pattern 61. In the example shown in FIG. 2, the underlying pattern 51 is formed in a distorted state like a parallelogram with respect to the rectangular design pattern 61.

The concave-convex pattern 21 of the template 110 is formed in accordance with the distortion (alignment error) of the underlying pattern 51 on the processing substrate 50. That is, the distortion amount of the concave-convex pattern 21 with respect to the master pattern 31 is the amount by which the pattern formed by transferring the shape of the concave-convex pattern 21 onto the underlying pattern 51 is made closer to the underlying pattern 51 relative to the design pattern 61. As an example, the distortion amount of the concave-convex pattern 21 with respect to the master pattern 31 is equal to the distortion amount of the underlying pattern 51 with respect to the design pattern 61.

Such a template 110 is used to transfer the shape of the concave-convex pattern 21 onto the underlying pattern 51. Then, the concave-convex pattern 21 can be formed at an accurate position matched with the distortion of the underlying pattern 51.

In the so-called nanoimprint method using this template 110, the shape of the concave-convex pattern 21 is transferred onto the underlying pattern 51. In the template 110 shown in FIG. 2, by a single transfer process, the shape of the concave-convex pattern 21 is transferred onto the underlying pattern 51 of one shot on the processing substrate 50. That is, in the case where there are underlying patterns 51 corresponding to a plurality of shots on the processing substrate 50, transfer with the template 110 is sequentially repeated for the underlying pattern 51 of each shot.

If the alignment errors for the respective shots of the underlying pattern 51 are in common, then in the transfer for each shot using the single template 110, the shape of the concave-convex pattern 21 can be transferred at an accurate position.

If the alignment errors for the respective shots of the underlying pattern 51 are different, then before transferring the shape of the concave-convex pattern 21 onto each underlying pattern 51, the concave-convex pattern 21 of the template 110 can be formed in accordance with the alignment error of the corresponding shot of the underlying pattern 51.

FIG. 3 shows an example in which rectangular regions of concave-convex patterns 21 corresponding to a plurality of shots are provided on the base substrate 10.

As shown in FIG. 3, in this template 120, rectangular regions of concave-convex patterns 21a-21d corresponding to four shots are formed on the base substrate 10. The concave-convex patterns 21a-21d formed in the respective rectangular regions have the same shape among the rectangular regions. Among them, the concave-convex pattern 21a is formed in a distorted state in accordance with the alignment error of the underlying pattern 51a. Likewise, the concave-convex patterns 21b, 21c, and 21d are formed in a distorted state in accordance with the alignment error of the underlying patterns 51b, 51c, and 51d, respectively.

In such a template 120, by a single transfer process, the shapes of the concave-convex patterns 21a-21d are transferred onto the underlying patterns 51a-51d of four shots on the processing substrate 50, respectively. The transfer using the template 120 is sequentially repeated in units of four underlying patterns 51a-51d.

In this template 120, a plurality of concave-convex patterns 21a-21d formed on one base substrate 10 are formed in accordance with the alignment error of the underlying patterns 51a-51d for each shot. Thus, on the underlying pattern 51a-51d for each shot, the shape of the corresponding concave-convex pattern 21a-21d can be transferred at an accurate position. This can improve the manufacturing yield of the device.

In the above example, concave-convex patterns 21a-21d corresponding to four shots are provided on one base substrate 10. However, the embodiment is also applicable to the case of providing concave-convex patterns corresponding to the number of shots other than four.

### Second Embodiment

Next, a template manufacturing method according to a second embodiment is described.

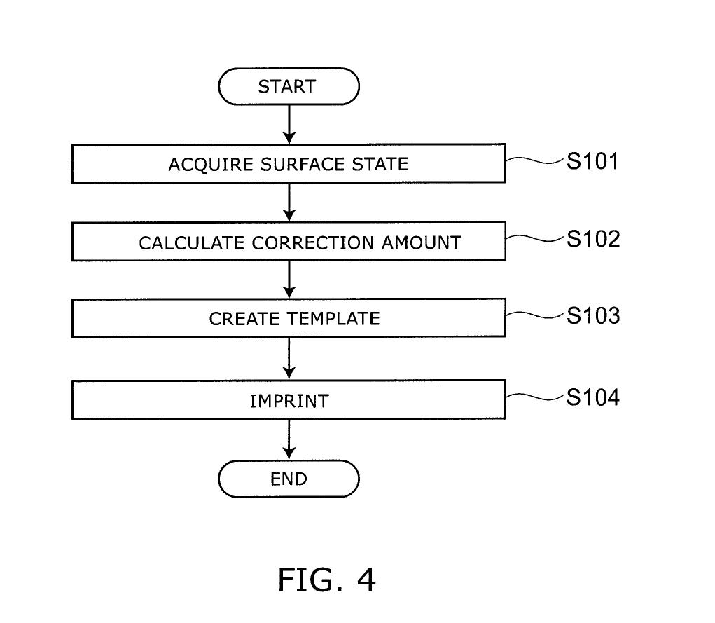

FIG. 4 is a flow chart illustrating the template manufacturing method according to the second embodiment.

Here, the processing of steps S101-S103 shown in FIG. 4 constitutes the template manufacturing method. FIG. 4 also shows imprinting (step S104) for transferring a pattern using the template manufactured by this manufacturing method.

The template manufacturing method according to the embodiment includes acquiring a surface state (step S101), calculating a correction amount (step S102), and creating a template (step S103). In the following, an example of each step is described. Here, as an example, a method for manufacturing the template 110 shown in FIG. 1 is described. Thus, reference numerals not shown in FIG. 4 refer to FIGS. 1 and 2.

First, the step of acquiring a surface state (step S101) acquires a surface state of the processing substrate (transfer target) 50 to which the concave-convex pattern 21 of the template 110 is to be transferred. Specifically, the alignment error in the shot of the underlying pattern 51 is acquired. The step of acquiring a surface state (step S101) may include the step of measuring the surface state. Furthermore, the step of acquiring a surface state (step S101) may include the step of acquiring a measurement result of the surface state from an instrument for measuring the surface state.

For instance, the instrument for measuring the surface state can be an alignment measuring device. The alignment measuring device measures a plurality of alignment marks present on the underlying pattern 51 formed by a shot. Then, the alignment measuring device calculates an alignment error for the entire shot from the measurement values (coordinate values) of the alignment marks.

Next, based on the information of the alignment error of the underlying pattern 51 acquired in the previous step S101, the step of calculating a correction amount (step S102) calculates a correction amount for the concave-convex pattern 21 matched with the alignment of the shot.

For instance, from the measurement value of the alignment mark, the distortion amount of the underlying pattern 51 is calculated. A correction amount for this distortion amount is determined by calculation.

Next, the step of creating a template (step S103) creates a concave-convex pattern 21 of the template 110 based on the correction amount calculated in the previous step S102. Specifically, a lateral stress is applied to the base substrate 10, which is e.g. a quartz substrate, to distort the base substrate 10. In this state, a concave-convex pattern 21 is created on the major surface 10a. Then, after creating the concave-convex pattern 21, the stress applied to the base substrate 10 is relieved. Thus, a template 110 having a concave-convex pattern 21 matched with the alignment of the underlying pattern 51 is created.

The step of imprinting (step S104) uses the template 110 created in steps S101-S103 to transfer the shape of the concave-convex pattern 21 of the template 110 onto the underlying pattern 51 of the processing substrate 50.

Even if the shot of the underlying pattern 51 has deviated from the ideal condition, by using the template 110 manufactured in the embodiment, the concave-convex pattern 21 can be accurately formed at a position matched with the alignment error of the underlying pattern 51.

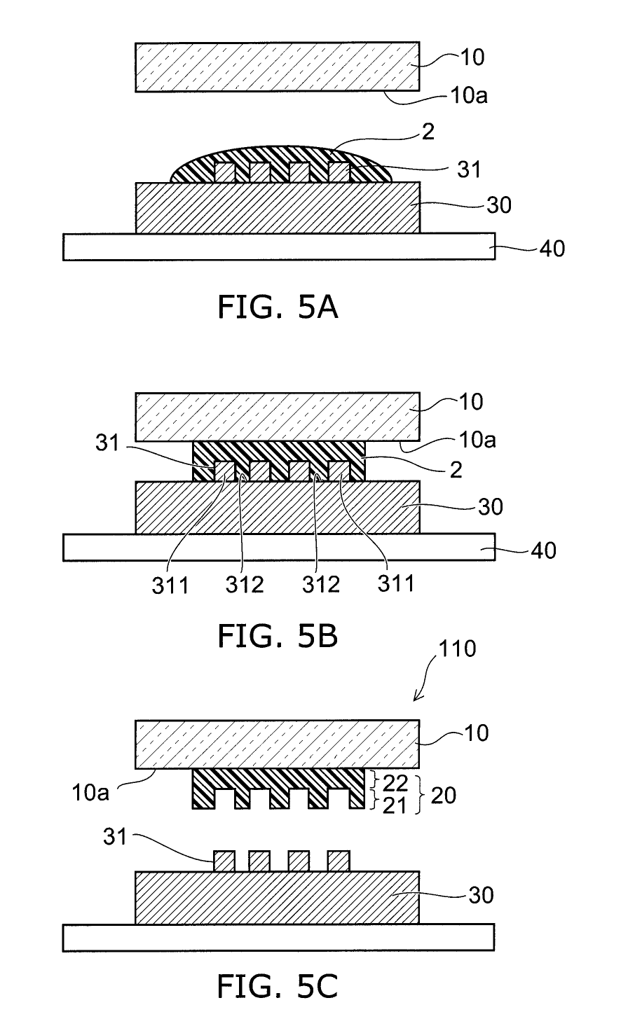

FIGS. 5A to 5C are schematic sectional views showing an example of the template manufacturing method.

FIGS. 5A to 5C illustrates a method for manufacturing the template 110 including a pattern portion 20 made of resin.

First, as shown in FIG. 5A, an original plate 30 with the master pattern 31 formed thereon, and a base substrate 10 are prepared. As the base substrate 10, for instance, a quartz substrate is used. The material of the original plate 30 is not particularly limited. For instance, a silicon wafer, quartz glass, or nickel substrate is used. The master pattern 31 of the original plate 30 is patterned by methods such as electron beam writing, light exposure, and the so-called nanoimprinting. The master pattern 31 is provided in a concave-convex shape by e.g. dry etching.

Then, on this original plate 30, a resin 2 is applied. Alternatively, the resin 2 may be applied to the major surface 10a of the base substrate 10. The material of the resin 2 is e.g. a photocurable resin or thermosetting resin.

Next, as shown in FIG. 5B, the original plate 30 and the major surface 10a of the base substrate 10 are opposed to each other so that the resin 2 is sandwiched therebetween. Then, in this state, the resin 2 is cured. In the case where the material of the resin 2 is a photocurable resin, the resin 2 is irradiated with prescribed light through the base substrate 10. Thus, the resin 2 is cured. In the case where the material of the resin 2 is a thermosetting resin, the resin 2 is cured by heating to a prescribed temperature.

Next, as shown in FIG. 5C, the base substrate 10 is separated from the original plate 30. On the major surface 10a of the base substrate 10, a pattern portion 20 of the cured resin 2 is formed. The concave-convex pattern 21 of the pattern portion 20 is a shape in which the shape of the master pattern 31 of the original plate 30 is transferred. The thickness of the intermediate portion 22 is determined by the spacing between the base substrate 10 and the original plate 30. Thus, a template 110 including the pattern portion 20 made of resin is completed.

The process shown in FIGS. 5A to 5C can manufacture the template 110 in several seconds to several minutes.

Here, from one original plate 30, a plurality of templates 110 can be created. Furthermore, from one template 110, the shape of the master pattern 31 can be transferred to a plurality of processing substrates 50.

For the used template 110, the pattern portion 20 is stripped from the base substrate 10 by e.g. ashing or washing treatment. After the pattern portion 20 is stripped, the base substrate 10 is reused.

For instance, a plurality of processing substrates 50 are managed in units of lots. The lot is associated with one base substrate 10. Before imprinting, the base substrate 10 is used to manufacture a template 110. Here, in manufacturing the template 110, the distortion matched with the alignment error of the underlying pattern 51 described above is provided in the concave-convex pattern 21.

The template 110 made of the resin 2 can be manufactured in a short time. Hence, even if a template 110 including a concave-convex pattern 21 matched with each shot of the processing substrate 50 is manufactured for each shot, the manufacturing time is not significantly delayed. On the other hand, the shape of the concave-convex pattern 21 can be accurately transferred in accordance with the alignment error of each shot. Hence, products with high yield can be provided.

As an example of matching the distortion of the concave-convex pattern 21 with the shot alignment error, in the embodiment, the step shown in FIG. 5B applies a distortion to the base substrate 10.

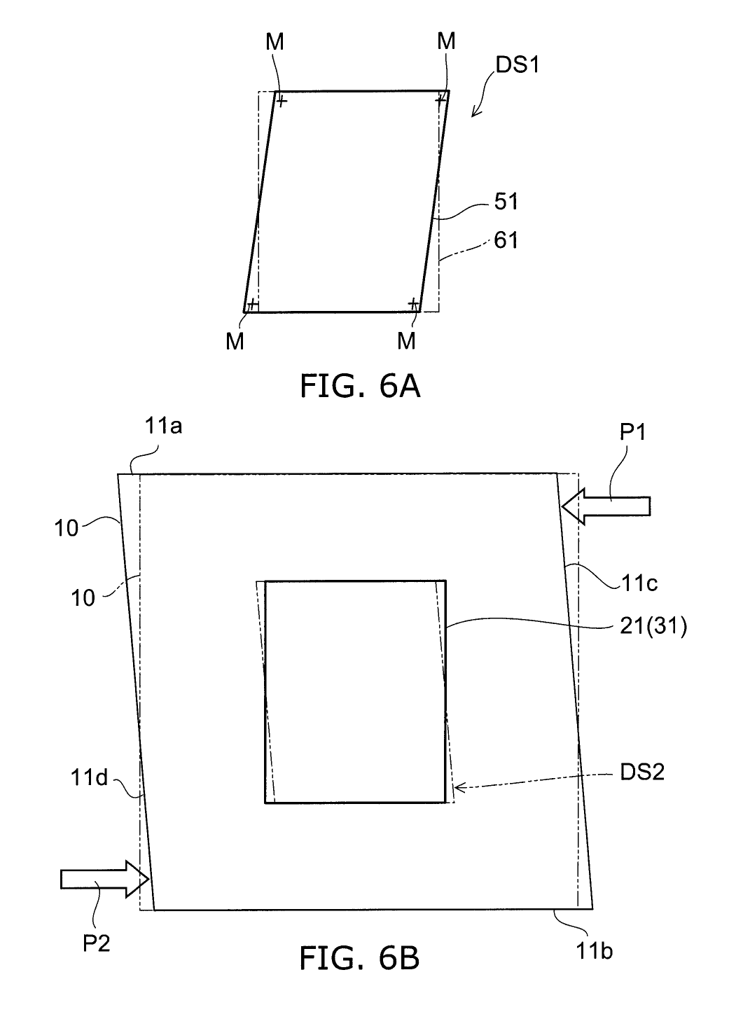

FIGS. 6A and 6B are schematic views describing an example of the formation of the concave-convex pattern.

FIG. 6A is a schematic plan view of the underlying pattern 51 and the design pattern 61. FIG. 6B is a schematic plan view illustrating the state of applying a distortion to the base substrate 10.

As shown in FIG. 6A, the underlying pattern 51 undergoes a distortion of a first distortion amount DS1 with respect to the design pattern 61. To determine the first distortion amount DS1, for instance, the coordinates of the alignment marks M provided at the corners of the underlying pattern 51 are measured. The first distortion amount DS1 can be determined by calculation from the coordinates of the alignment marks M.

In forming the concave-convex pattern 21 of the template 110, a distortion is applied to the base substrate 10 so that the formed concave-convex pattern 21 is matched with the first distortion amount DS1 of the underlying pattern 51. Specifically, as shown in FIG. 6B, stresses P1 and P2 are applied to the base substrate 10 so that a distortion of a second distortion amount DS2 is applied to the region of the base substrate 10 where the concave-convex pattern 21 is to be formed.

The second distortion amount DS2 is the reverse of the first distortion amount DS1. The base substrate 10 is a rectangular substrate having first to fourth sides 11a-11d. In the rectangular base substrate 10, the first side 11a and the second side 11b are opposed to each other, and the third side 11c and the fourth side 11d are opposed to each other.

The second distortion amount DS2 is the reverse of the distortion amount of the underlying pattern 51 distorted like a parallelogram with respect to the rectangular design pattern 61. To the region of the base substrate 10 where the concave-convex pattern 21 is to be formed, a distortion of the second distortion amount DS2 can be applied as follows, for instance. A stress P1 is applied to the end portion of the third side 11c close to the first side 11a. A stress P2 is applied to the end portion of the fourth side 11d close to the second side 11b. The stresses P1 and P2 are produced by forces in the elastic deformation region of the base substrate 10. Thus, the entirety of the base substrate 10 is elastically deformed like a parallelogram. With this deformation, the region for forming a concave-convex pattern 21 is also deformed like a parallelogram. That is, the region for forming a concave-convex pattern 21 is distorted by the second distortion amount DS2.

Then, in this state, as shown in FIG. 5B, the master pattern 31 of the original plate 30 is transferred to the resin 2 on the base substrate 10. As shown in FIG. 6B, no distortion occurs in the concave-convex pattern 21 formed on the base substrate 10 by this transfer.

As shown in FIG. 5C, the resin 2 is cured, and the original plate 30 is separated from the base substrate 10. Then, the stresses P1 and P2 applied to the base substrate 10 shown in FIG. 6B are relieved. Thus, the base substrate 10 returns to the original rectangular shape.

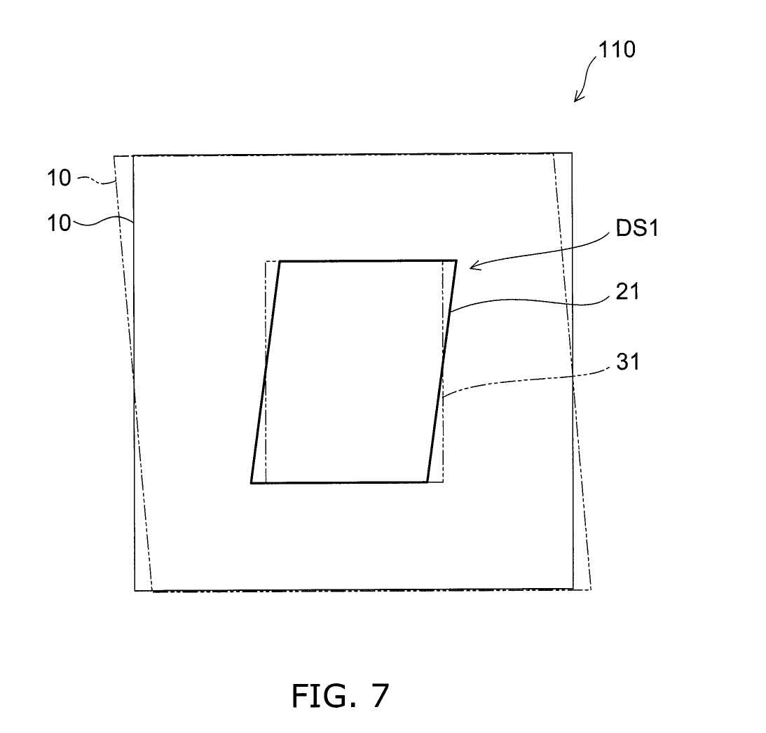

FIG. 7 is a schematic view describing an example template with a concave-convex pattern formed thereon.

The base substrate 10 having been elastically deformed returns to the original rectangular shape. Then, the concave-convex pattern 21 formed on this base substrate 10 is distorted oppositely. That is, a first distortion amount DS1 is applied to the concave-convex pattern 21. The first distortion amount DS1 is the reverse distortion amount of the second distortion amount DS2.

Here, the underlying pattern 51 shown in FIGS. 6A and 6B is distorted like a parallelogram with respect to the design pattern 61. However, the embodiment is also applicable to other distortions. For instance, the distortion may be such that the underlying pattern 51 is expanded with respect to the design pattern 61. In this case, the region where the concave-convex pattern 21 is to be formed can be contracted by the stress applied to the base substrate 10. More specifically, a stress is applied to the base substrate 10 so that the second distortion amount DS2 being the reverse of the first distortion amount DS1 is applied to the region for forming the concave-convex pattern 21. In this state, the concave-convex pattern 21 is formed.

Next, an example of the pattern formation method based on the imprint method is described.

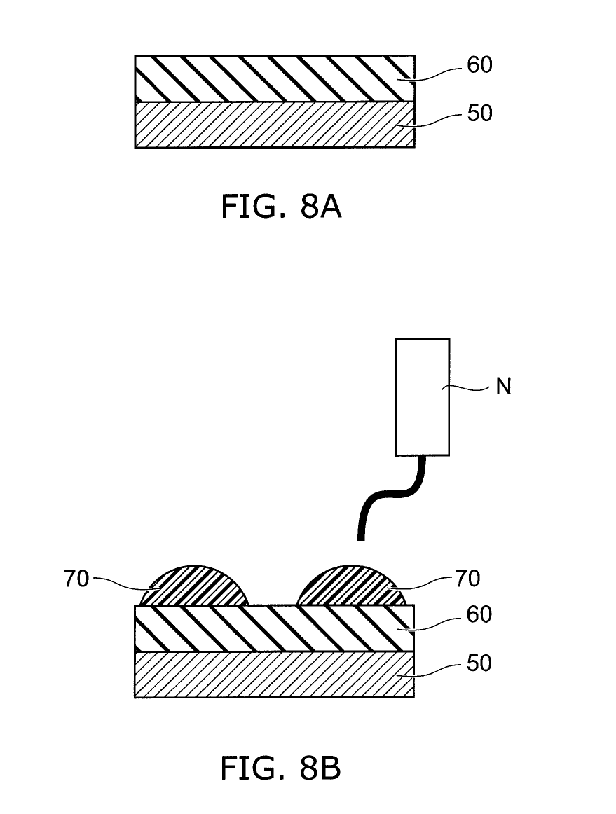

FIGS. 8A to 10B are schematic sectional views illustrating the pattern formation method based on the imprint method.

First, as shown in FIG. 8A, a shaping object 60 is provided on a processing substrate 50. As the processing substrate 50, for instance, a silicon wafer is used. The shaping object 60 is made of e.g. silicon oxide.

Next, as shown in FIG. 8B, a transfer target 70 is provided on the shaping object 60. The transfer target 70 is made of e.g. a thermosetting resin or photocurable resin. In the embodiment, as an example, a photocurable resin is used. For instance, the transfer target 70 is dropped onto the shaping object 60 from a nozzle N by the ink jet method. Alternatively, the transfer target 70 may be uniformly provided by e.g. spin coating.

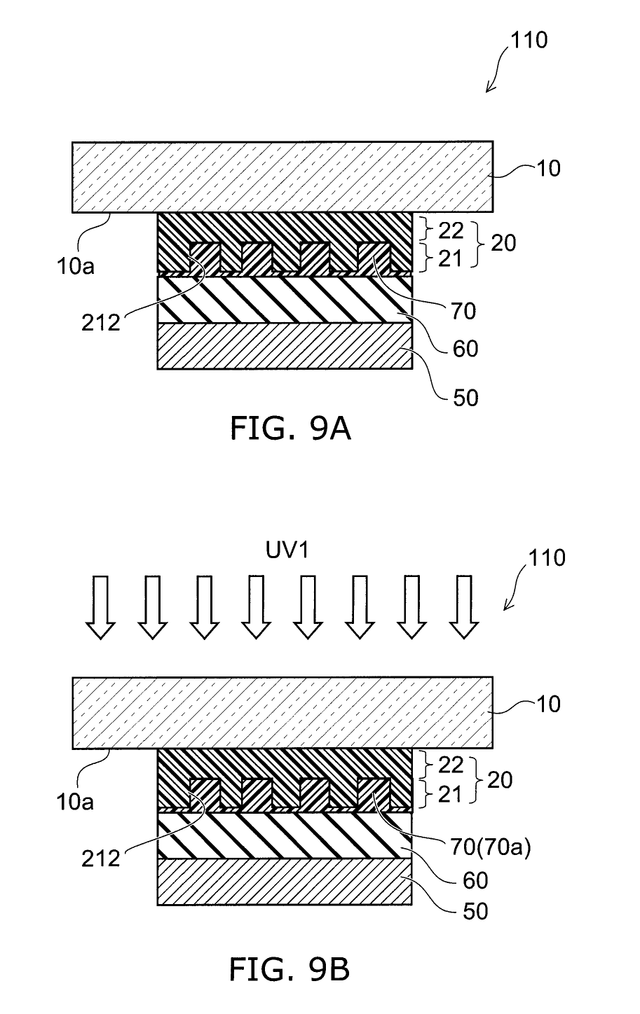

Next, as shown in FIG. 9A, the pattern portion 20 of the template 110 is brought into contact with the transfer target 70. At this time, a small gap (e.g., several nanometers (nm)) is provided between the tip of the concave-convex pattern 21 of the pattern portion 20 and the surface of the transfer target 70. By capillarity, the transfer target 70 penetrates into the concave pattern 212 of the concave-convex pattern 21 and is filled in the concave pattern 212.

As described above, the concave-convex pattern 21 of the template 110 is formed in a distorted state in accordance with the distortion of the underlying pattern to which the shape of this concave-convex pattern 21 is to be transferred. Although not shown in FIGS. 9A and 9B, in the case where an underlying pattern is formed on the processing substrate 50, a distortion is provided in the concave-convex pattern 21 in accordance with the distortion of this underlying pattern. Hence, when the pattern portion 20 of the template 110 is brought into contact with the transfer target 70, the concave-convex pattern 21 is accurately aligned with the underlying pattern on the processing substrate 50.

Next, as shown in FIG. 9B, with the pattern portion 20 of the template 110 brought into contact with the transfer target 70, ultraviolet radiation UV1 is applied from the base substrate 10 side of the template 110. The ultraviolet radiation UV1 is transmitted through the base substrate 10 and the pattern portion 20 and applied to the transfer target 70. The transfer target 70 made of the photocurable resin is cured by irradiation with the ultraviolet radiation UV1.

The wavelength of the ultraviolet radiation UV1 is e.g. approximately 300-400 nm. Here, the base substrate 10 and the pattern portion 20 are made of materials sufficiently translucent to the ultraviolet radiation UV1. The transfer target 70 is cured into a transfer pattern 70a having an inverted concave-convex shape of the concave-convex pattern 21. By using the template 110, the transfer pattern 70a is formed in accordance with the distortion of the underlying pattern (not shown) provided on the processing substrate 50.

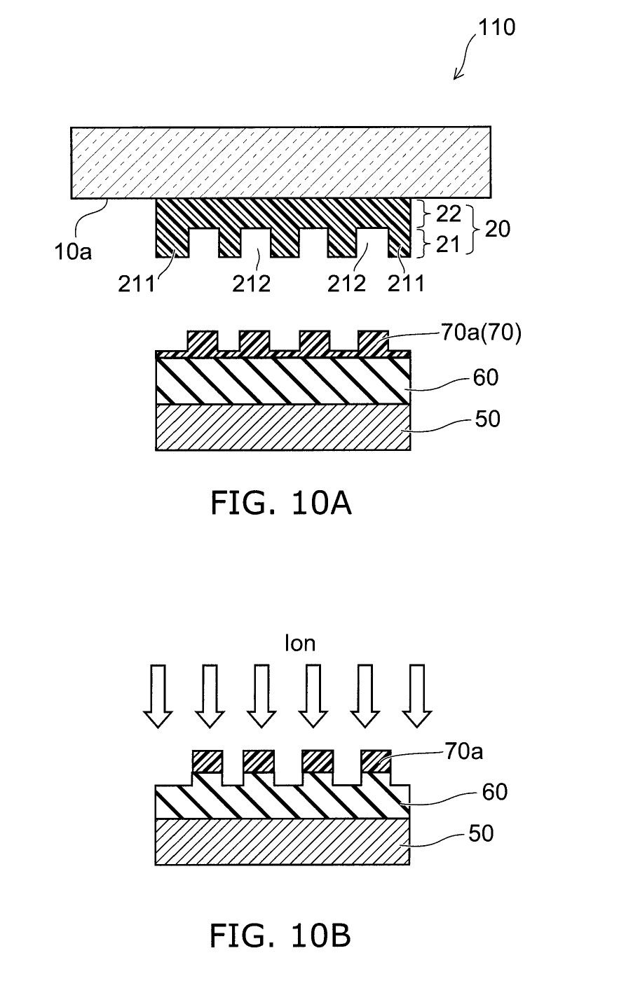

Next, as shown in FIG. 10A, the template 110 is released from the transfer pattern 70a. Here, the adhesive strength between the base substrate 10 and the pattern portion 20 is stronger than the adhesive strength between the transfer pattern 70a and the pattern portion 20. Hence, when the template 110 is released, the pattern portion 20 is not peeled from the base substrate 10.

Next, as shown in FIG. 10B, the transfer pattern 70a formed on the shaping object 60 is used as a mask to etch the shaping object 60 by e.g. anisotropic RIE (reactive ion etching). After the etching, the transfer pattern 70a is removed. Thus, a pattern corresponding to the transfer pattern 70a is formed in the shaping object 60.

### Third Embodiment

Next, a template manufacturing method according to a third embodiment is described.

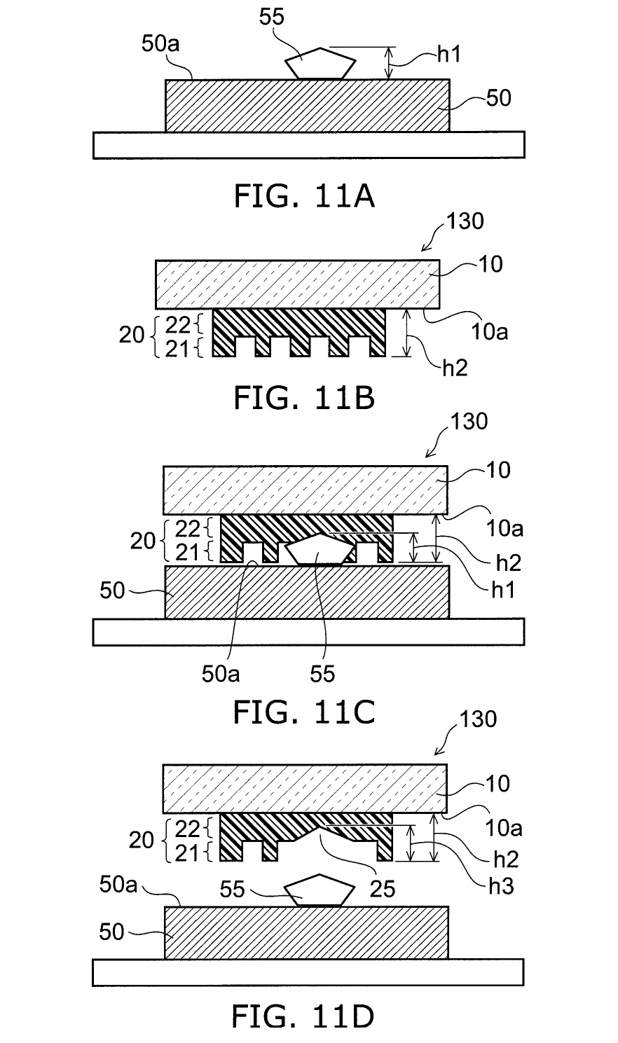

FIGS. 11A to 11D are schematic sectional views illustrating the template manufacturing method according to the third embodiment.

The flow of the template manufacturing method according to the embodiment is similar to the flow chart shown in FIG. 4. Among the steps shown in FIG. 4, in the embodiment, the step of acquiring a surface state (step S101) includes the step of acquiring the maximum height of foreign matter attached to the surface of the processing substrate 50. Furthermore, in the embodiment, the step of creating a template (step S103) includes the step of making the thickness of the pattern portion 20 thicker than the maximum height of the foreign matter.

Next, an example of the embodiment is described with reference to FIGS. 11A to 11D.

First, as shown in FIG. 11A, it is assumed that foreign matter 55 is attached to the surface of the processing substrate 50. Here, the surface state of the processing substrate 50 is acquired. For instance, the presence or absence of foreign matter 55 on the surface of the processing substrate 50 is inspected by e.g. a surface inspection device or foreign matter inspection device. If there is any foreign matter 55, its maximum height (the height from the surface 50a of the processing substrate 50) h1 is measured.

Next, shown in FIG. 11B, a pattern portion 20 made of resin is formed on the major surface 10a of the base substrate 10. The step of forming a pattern portion 20 is the same as the step illustrated in FIGS. 5A to 5C. At this time, by adjusting the application amount of the resin 2 and the spacing between the original plate 30 and the base substrate 10, the height h2 of the formed pattern portion 20 from the major surface 10a is made larger than or equal to the maximum height h1 of the foreign matter 55. Specifically, by adjusting the thickness of the intermediate portion 22 of the pattern portion 20, the height h2 of the pattern portion 20 is made larger than or equal to the maximum height h1 of the foreign matter 55. Thus, the template 130 is completed.

Next, imprinting using this template 130 is described.

FIGS. 11C and 11D illustrate the states of imprinting using the template 130. In FIGS. 11C and 11D, for convenience of description, the transfer target 70 (see FIGS. 9A and 9B) to which the concave-convex pattern 21 is to be transferred is omitted.

As shown in FIG. 11C, when the template 130 is opposed to the processing substrate 50, the foreign matter 55 attached to the surface 50a of the processing substrate 50 is sandwiched therebetween. If the foreign matter 55 is harder than the pattern portion 20, the foreign matter 55 digs into the pattern portion 20. At this time, the height h2 of the pattern portion 20 is larger than or equal to the maximum height h1 of the foreign matter 55. Furthermore, a small gap is provided between the tip of the pattern portion 20 and the surface of the processing substrate 50. Hence, the foreign matter 55 is not bought into contact with the major surface 10a of the base substrate 10.

Next, as shown in FIG. 11D, the template 130 is separated from the processing substrate 50. If the foreign matter 55 has dug into the pattern portion 20, the foreign matter 55 produces a missing portion 25 in the pattern portion 20. The depth h3 of the missing portion 25 from the tip of the pattern portion 20 is shallower than the height h2 of the pattern portion 20. That is, even if imprinting is performed with the foreign matter 55 attached to the processing substrate 50, the foreign matter 55 is not bought into contact with the major surface 10a of the base substrate 10. Hence, even if a missing portion 25 occurs in the pattern portion 20, there is no influence such as flaws on the base substrate 10.

If a missing portion 25 occurs in the pattern portion 20, the pattern portion 20 can be stripped from the base substrate 10. After the pattern portion 20 is stripped, the base substrate 10 is reused. Thus, using the same base substrate 10, a pattern portion 20 can be formed again, and a new template 130 can be formed.

According to the embodiment, even if there is foreign matter 55 on the surface of the processing substrate 50, the base substrate 10 can be used for the next transfer processing without influence such as flaws on the base substrate 10 of the template 130. This can contribute to reducing the manufacturing cost of the template 130.

### Fourth Embodiment

Next, a template manufacturing method according to a fourth embodiment is described.

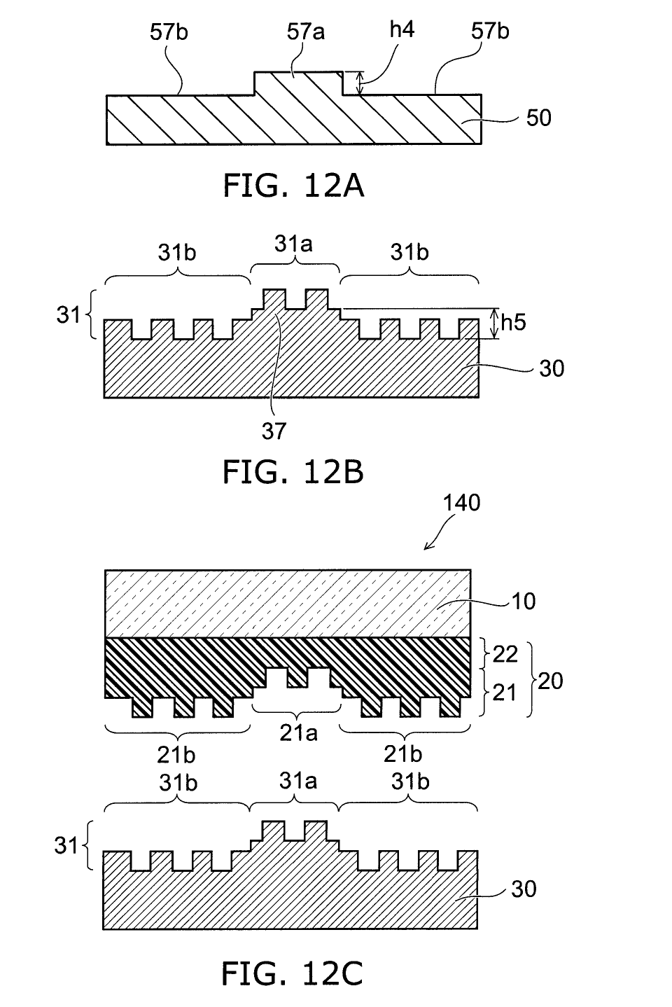

FIGS. 12A to 12C are schematic sectional views illustrating the template manufacturing method according to the fourth embodiment.

The flow of the template manufacturing method according to the embodiment is similar to the flow chart shown in FIG. 4. Among the steps shown in FIG. 4, in the embodiment, the step of acquiring a surface state (step S101) includes the step of acquiring the height of a convex portion 57a present in the processing substrate 50. Furthermore, in the embodiment, the step of creating a template (step S103) includes the step of forming a concave-convex pattern 21 using a master pattern 31 including a convex-shaped pattern 37 matched with the height of the convex portion 57a.

Next, an example of the embodiment is described with reference to FIGS. 12A to 12C.

First, as shown in FIG. 12A, the height h4 of the convex portion 57a present in the processing substrate 50 is measured. The convex portion 57a is a portion of the processing substrate 50 where the thickness is relatively thick. The portion (the portion of the processing substrate 50 where the thickness is relatively thin) neighboring the convex portion 57a is a concave portion 57b. This concave portion 57b and the convex portion 57a constitute a step difference at the surface of the processing substrate 50. The height h4 of the convex portion 57a may depend on e.g. the condition in forming the convex portion 57a.

Next, as shown in FIG. 12B, an original plate 30 including a convex-shaped pattern 37 matched with the measured height h4 is prepared. This original plate 30 is provided with a master pattern 31. The master pattern 31 includes a concave-convex pattern 31a corresponding to the shape of the concave-convex pattern to be formed on the convex portion 57a of the processing substrate 50, and a concave-convex pattern 31b corresponding to the shape of the concave-convex pattern to be formed on the concave portion 57b. Among them, the concave-convex pattern 31a is formed on the convex-shaped pattern 37.

The height h5 of the convex-shaped pattern 37 (the height with reference to the bottom surface of the concave portion of the concave-convex pattern 31b) is matched with the height h4 of the convex portion 57a of the processing substrate 50. In the embodiment, an original plate 30 is prepared in which the height h5 of the convex-shaped pattern 37 is matched with the height h4 of the convex portion 57a measured previously. Such an original plate 30 is formed after measuring the height h4 of the convex portion 57a. Alternatively, after measuring the height h4 of the convex portion 57a, the original plate 30 may be appropriately selected from among a plurality of original plates 30 including convex-shaped patterns 37 with different heights h5.

Then, as shown in FIG. 12C, using this original plate 30, a pattern portion 20 made of resin is formed on the major surface 10a of the base substrate 10. The step of forming a pattern portion 20 is the same as the step illustrated in FIGS. 5A to 5C. The concave-convex pattern 21 of the pattern portion 20 includes a concave-convex pattern 21a having an inverted shape of the concave-convex pattern 31a of the original plate 30, and a concave-convex pattern 21b having an inverted shape of the concave-convex pattern 31b of the original plate 30. The concave-convex pattern 21a is formed with reference to the convex-shaped pattern 37 of the original plate 30. Thus, the template 140 is completed.

Next, imprinting using this template 140 is described.

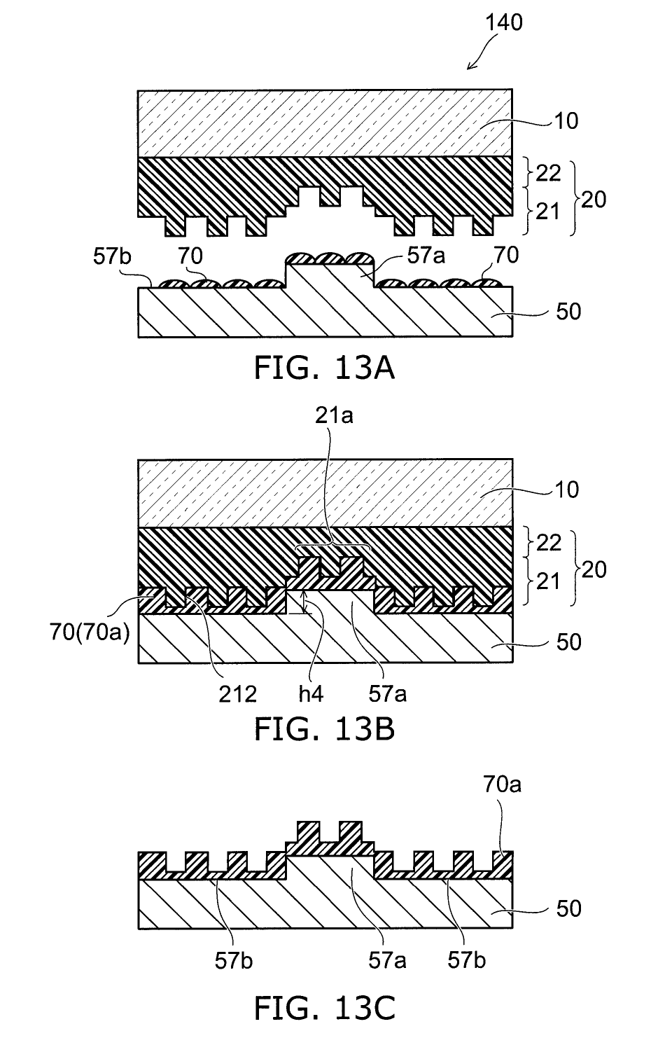

FIGS. 13A to 13C are schematic sectional views describing the imprinting.

First, as shown in FIG. 13A, a transfer target 70 is applied onto the processing substrate 50. The transfer target 70 is applied onto the convex portion 57a and the concave portion 57b of the processing substrate 50. Then, the template 140 and the processing substrate 50 are opposed to each other.

Next, as shown in FIG. 13B, the pattern portion 20 of the template 140 is brought into contact with the transfer target 70. At this time, a small gap (e.g., several nm) is provided between the tip of the concave-convex pattern 21 of the pattern portion 20 and the surface of the transfer target 70. By capillarity, the transfer target 70 penetrates into the concave pattern 212 of the concave-convex pattern 21 and is filled in the concave pattern 212. Here, the template 140 has been formed using the original plate 30 matched with the height h4 of the convex portion 57a of the processing substrate 50. Hence, the spacing between the convex portion 57a and the concave-convex pattern 21a can be set as designed.

Then, in this state, the transfer target 70 is cured by light irradiation or heating. After curing the transfer target 70, the template 140 is released. Thus, as shown in FIG. 13C, a transfer pattern 70a having an inverted concave-convex shape of the concave-convex pattern 21 is formed on the processing substrate 50. The transfer pattern 70a is accurately formed on both the convex portion 57a and the concave portion 57b of the processing substrate 50.

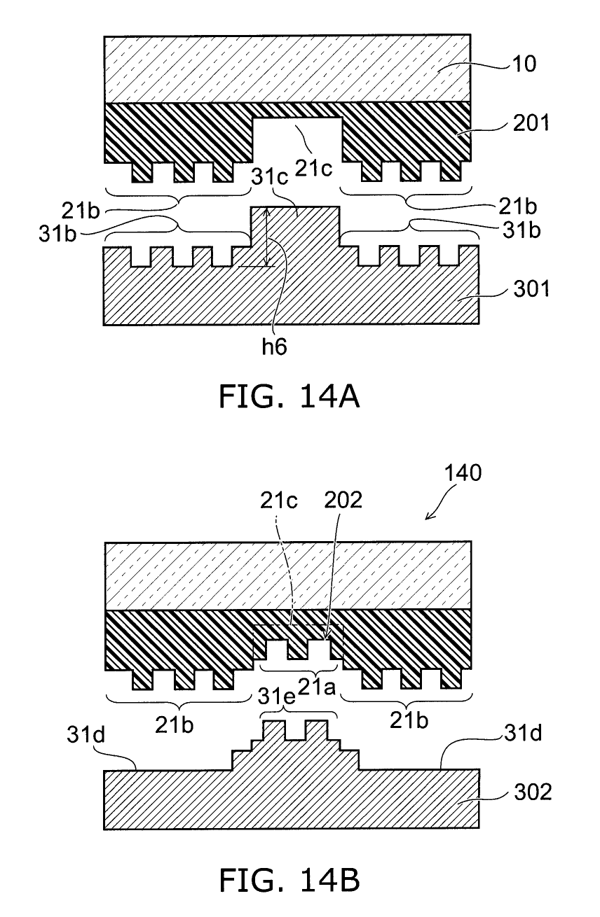

FIGS. 14A and 14B are schematic sectional views illustrating an alternative template manufacturing method.

More specifically, FIGS. 14A and 14B illustrate an alternative method for manufacturing the template 140. In the process illustrated in FIGS. 14A and 14B, after measuring the height h4 of the convex portion 57a of the processing substrate 50 shown in FIG. 12A, an alternative process is used to form the template 140 in accordance with this height h4.

First, as shown in FIG. 14A, a first original plate 301 is prepared. The first original plate 301 includes a convex flat portion 31c in the portion corresponding to the position of the convex portion 57a (see FIG. 12A). Furthermore, the first original plate 301 includes a concave-convex pattern 31b neighboring the convex flat portion 31c. The height h6 of the convex flat portion 31c (the height from the bottom of the concave portion of the concave-convex pattern 31b) is sufficiently higher than the total height of the measured height h4 of the convex portion 57a and the height of the convex pattern to be formed on this convex portion 57a.

By using this first original plate 301, a first pattern portion 201 including a concave-convex pattern 21b is formed on the major surface 10a of the base substrate 10. The first pattern portion 201 is provided with a concave flat portion 21c having an inverted shape of the convex flat portion 31c of the first original plate 301.

Next, as shown in FIG. 14B, a second original plate 302 is prepared. The second original plate 302 includes a concave-convex pattern 31e at the position corresponding to the concave flat portion 21c of the first pattern portion 201 formed previously. Furthermore, the second original plate 302 includes a flat portion 31d at the position neighboring the concave-convex pattern 31e.

By using this second original plate 302, a second pattern portion 202 is formed in the first pattern portion 201. More specifically, the second pattern portion 202 includes a concave-convex pattern 21a formed in the concave flat portion 21c of the first pattern portion 201. The concave-convex pattern 21a is constituted by a resin filled between the concave flat portion 21c and the concave-convex pattern 31e. No resin is interposed between the concave-convex pattern 21b and the flat portion 31d. Hence, no pattern is formed therein.

When the concave-convex pattern 21a is formed in this concave flat portion 21c, the spacing between the concave-convex pattern 31e of the second original plate 302 and the concave flat portion 21c is adjusted in accordance with the height h4 of the convex portion 57a measured previously. Thus, the template 104 is completed. This manufacturing method can also manufacture the template 104 matched with the height h4 of the convex portion 57a of the processing substrate 50.

The template 104 described above is an example including a concave-convex pattern 21a in which the transfer pattern 70a is formed on both the convex portion 57a and the concave portion 57b of the processing substrate 50. However, the embodiment is also applicable to an example in which the concave-convex pattern 21 is formed on one of the convex portion 57a and the concave portion 57b of the processing substrate 50.

According to the embodiment, even if a step difference is provided on the processing substrate 50, the transfer pattern 70a can be accurately formed on the processing substrate 50 by the template 140 matched with the step difference. This can contribute to improving the manufacturing yield of the device.

### Fifth Embodiment

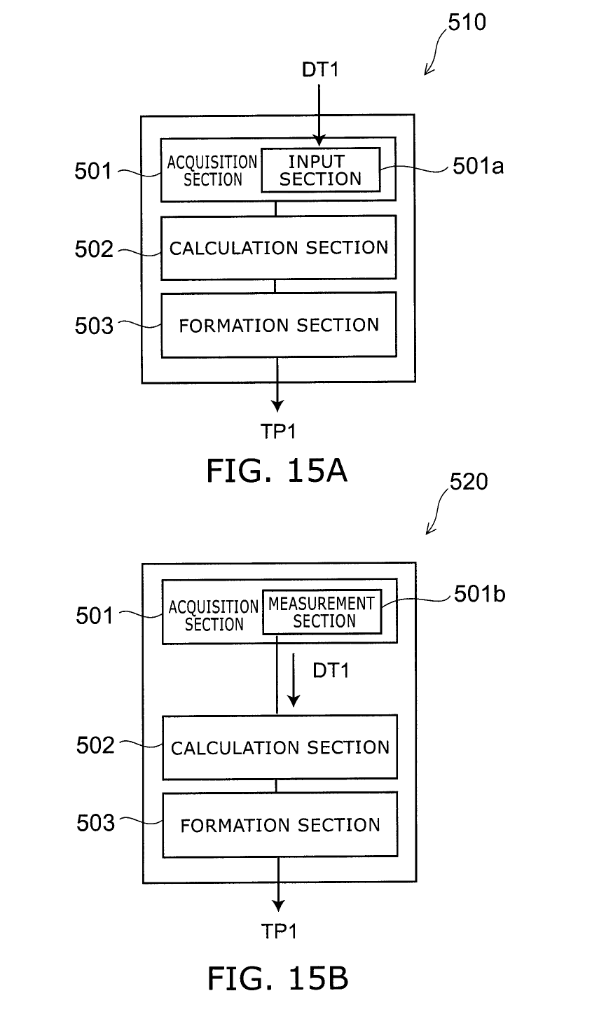

FIGS. 15A and 15B are block diagrams illustrating the configuration of a template manufacturing apparatus according to a fifth embodiment.

FIG. 15A shows a first configuration example. FIG. 15B shows a second configuration example.

As shown in FIG. 15A, the template manufacturing apparatus 510 according to the first configuration example includes an acquisition section 501, a calculation section 502, and a formation section 503.

The acquisition section 501 performs processing for acquiring a surface state of the substrate to which the shape of the concave-convex pattern in the pattern portion of the template is to be transferred. In the first configuration example, the acquisition section 501 includes an input section 501a. The input section 501a performs processing for inputting the surface state of the substrate from outside. More specifically, the input section 501a performs processing for inputting the information DT1 of the surface state from an external measurement device.

The external measurement device can be e.g. an alignment measurement device, surface inspection device, or foreign matter inspection device. In the case of the alignment measurement device, the information DT1 represents measurement values (coordinate values) of alignment marks M of the underlying pattern 51 shown in FIGS. 6A and 6B. In the case of the surface inspection device and foreign matter inspection device, the information DT1 represents the height h1 of foreign matter 55 shown in FIG. 11A and the height h4 of the convex portion 57a of the processing substrate 50 shown in FIG. 12A.

The calculation section 502 performs processing for calculating a correction amount for the concave-convex pattern from the information DT1 of the surface state acquired by the acquisition section 501. For instance, in the case where the information DT1 represents measurement values of alignment marks M, the calculation section 502 calculates the distortion amount of the underlying pattern 51 from the measurement values of alignment marks M, and calculates a correction amount corresponding to this distortion amount. In the case where the information DT1 represents the height h1 of foreign matter 55 and the height h4 of the convex portion 57a, the calculation section 502 calculates a correction amount for the pattern portion 20 corresponding to these heights h1 and h4.

The formation section 503 performs processing for forming a concave-convex pattern with correction by the correction amount calculated by the calculation section 502 in forming a pattern portion on the base substrate. More specifically, the formation section 503 performs processing for forming the template 110, 120, 130, and 140 by steps S101-S103 shown in FIG. 4.

This template manufacturing apparatus 510 can manufacture the template 110 and 120 including a concave-convex pattern 21 matched with the distortion of the underlying pattern 51, and the template 130 and 140 including a pattern portion 20 matched with the heights h1 and h4 on the processing substrate 50.

As shown in FIG. 15B, the template manufacturing apparatus 520 according to the second configuration example includes an acquisition section 501, a calculation section 502, and a formation section 503.

The acquisition section 501 performs processing for acquiring a surface state of the substrate to which the shape of the concave-convex pattern in the pattern portion of the template is to be transferred. In the second configuration example, the acquisition section 501 includes a measurement section 501b. The measurement section 501b performs processing for measuring the surface state of the substrate. More specifically, in the manufacturing apparatus 520, the measurement section 501b provided therein measures the surface state of the substrate to which the shape of the concave-convex pattern of the template is to be transferred. The measurement section 501b outputs the information DT1 of the measured surface state to the calculation section 502.

The measurement section 501b can perform processing for measuring e.g. the coordinate values of alignment marks M of the underlying pattern 51 shown in FIGS. 6A and 6B. The measurement section 501b can perform processing for measuring e.g. the height h1 of foreign matter 55 shown in FIG. 11A and the height h4 of the convex portion 57a of the processing substrate 50 shown in FIG. 12A.

The processing of the calculation section 502 and the formation section 503 is the same as that of the first configuration example shown in FIG. 15A.

This template manufacturing apparatus 520 can manufacture the template 110 including a concave-convex pattern 21 matched with the distortion of the underlying pattern 51, and the template 140 including a pattern portion 20 matched with the heights h1 and h4 on the processing substrate 50.

### Sixth Embodiment

Next, a template manufacturing program according to a sixth embodiment is described.

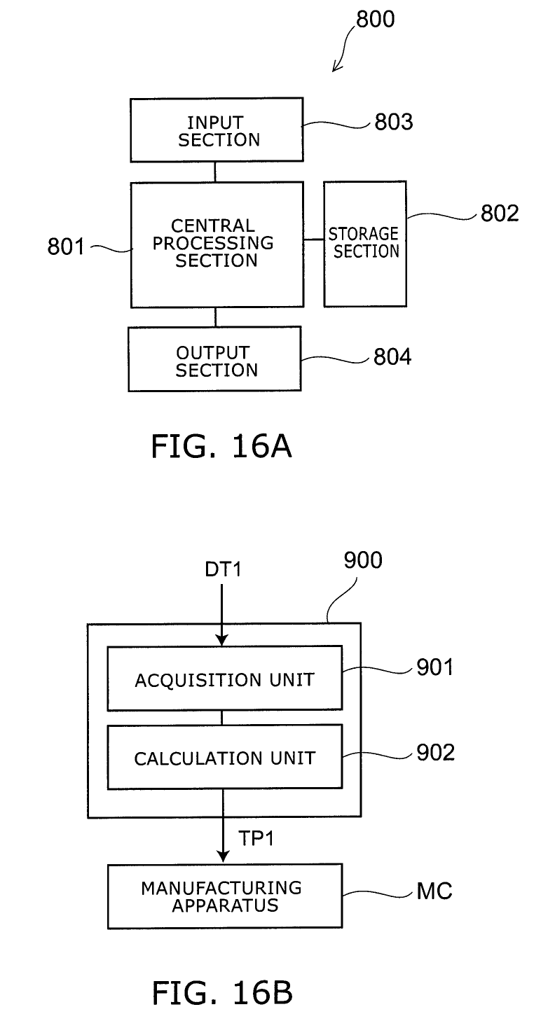

FIGS. 16A and 16B describe a computer on which the program according to the embodiment is executed.

More specifically, FIG. 16A is a block diagram showing a configuration example of the computer.

FIG. 16B is a block diagram describing the function of the template manufacturing program according to the embodiment.

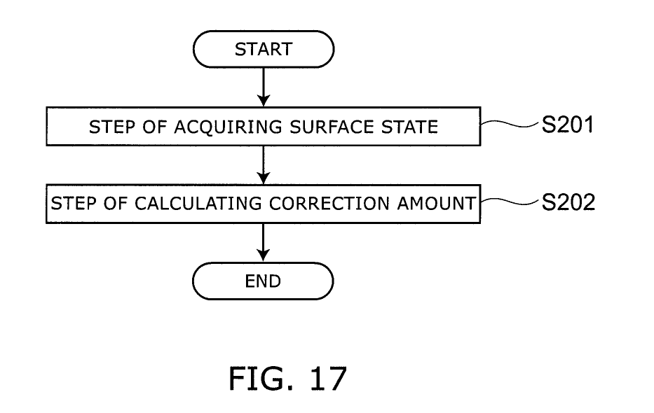

FIG. 17 is a flow chart illustrating the processing flow of the program according to the embodiment.

As shown in FIG. 16A, the computer 800 includes a central processing section 801, a storage section 802, an input section 803, and an output section 804. The central processing section 801 is a section for executing the template manufacturing program according to the embodiment. The storage section 802 includes a RAM (random access memory) for temporarily storing information such as the manufacturing program executed, and other storage devices such as ROM (read only memory), HDD (hard disk drive), and semiconductor memory drive.

The input section 803 includes a keyboard and a pointing device as well as interfaces for inputting information from external devices through e.g. a network. The output section 804 includes a display as well as interfaces for outputting information to external devices.

As shown in FIG. 16B, the template manufacturing program 900 according to the embodiment causes the computer 800 (see FIG. 16A) to function as an acquisition unit 901 and a calculation unit 902.

The acquisition unit 901 performs processing for acquiring a surface state of the substrate to which the concave-convex pattern in the pattern portion of the template is to be transferred (step S201 of FIG. 17). That is, the acquisition unit 901 performs processing for retrieving the information DT1 of the surface state from an external device into the computer 800. Specifically, the acquisition unit 901 uses the input section 803 of the computer 800 to retrieve the information DT1 of the surface state into the central processing section 801. The information DT1 is stored in the storage section 802 as necessary.

In the case where the external device is an alignment measurement device, the acquisition unit 901 acquires, as the information DT1, measurement values (coordinate values) of alignment marks of the underlying pattern measured by the alignment measurement device. In the case where the external device is a surface inspection device or foreign matter inspection device, the acquisition unit 901 acquires, as the information DT1, the height of the substrate surface inspected by the surface inspection device or foreign matter inspection device.

The calculation unit 902 performs processing for calculating a correction amount for the concave-convex pattern from the information DT1 of the surface state acquired by the acquisition unit 901 (step S202 of FIG. 17). Specifically, the calculation unit 902 calculates a correction amount using the information DT1 by the central processing section 801 of the computer 800 and outputs a calculation result TP1.

In the case where the information DT1 represents measurement values of alignment marks, the calculation unit 902 calculates the distortion amount of the underlying pattern from the measurement values of alignment marks, and calculates a correction amount corresponding to this distortion amount. In the case where the information DT1 represents the height of the substrate surface, the calculation section 502 calculates a correction amount for the pattern portion corresponding to this height. The calculation result TP1 produced by the calculation unit 902 is outputted in a prescribed data format from the output section 804 of the computer 800. Then, the calculation result TP1 is sent to an external manufacturing device MC.

The manufacturing device MC manufactures a template by applying correction to the pattern portion using the calculation result TP1. Thus, a template including a pattern portion matched with the underlying pattern can be manufactured.

The template manufacturing program according to the embodiment can be practiced as an implementation executed on a computer as described above. Furthermore, the template manufacturing program according to the embodiment can also be practiced as an implementation stored in a prescribed storage medium. Furthermore, the template manufacturing program according to the embodiment can also be practiced as an implementation distributed via a network.

As described above, the embodiments can provide a template, a template manufacturing method, a template manufacturing apparatus, and a template manufacturing program capable of improving the pattern transfer accuracy.

The embodiments and the variations thereof have been described above. However, the invention is not limited to these examples. For instance, those skilled in the art can modify the above embodiments or the variations thereof by suitable addition, deletion, and design change of components, and by suitable combination of the features of the embodiments. Such modifications are also encompassed within the scope of the invention as long as they fall within the spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A template comprising:
a base substrate; and
a pattern portion provided on the base substrate and including a concave-convex pattern formed from a master pattern,
the concave-convex pattern being provided in a distorted state with respect to the master pattern in accordance with a distortion of an underlying pattern formed on a substrate to which a shape of the concave-convex pattern is to be transferred.

2. The template according to claim 1, wherein distortion amount of the concave-convex pattern with respect to the master pattern is such that when the shape of the concave-convex pattern is transferred onto the underlying pattern, the transferred pattern is made closer to the underlying pattern relative to a design value of the underlying pattern.

3. The template according to claim 1, wherein the pattern portion includes a plurality of rectangular regions with the same concave-convex pattern formed therein.

4. The template according to claim 1, wherein the pattern portion includes a resin.

5. A template manufacturing method comprising:
acquiring a surface state of a transfer target to which a shape of a concave-convex pattern included in a pattern portion is to be transferred;
determining a correction amount for the concave-convex pattern from the surface state; and
forming the pattern portion on a base substrate with the concave-convex pattern formed with correction by the correction amount.

6. The method according to claim 5, wherein the forming the pattern portion includes:
applying a resin to an original plate with a master pattern formed thereon or the base substrate;
sandwiching the resin between the base substrate and the original plate while applying a stress based on the correction amount to the base substrate;
curing the resin; and
releasing the original plate from the resin.

7. The method according to claim 6, wherein the resin is a photocurable resin.

8. The method according to claim 6, wherein the resin is a thermosetting resin.

9. The method according to claim 5, wherein the forming the pattern portion includes:
acquiring a first distortion amount of an underlying pattern formed on the substrate from the surface state;
forming the concave-convex pattern from a master pattern while applying a distortion of a second distortion amount to a region of the base substrate where the concave-convex pattern is formed, the second distortion amount being reverse of the first distortion amount; and
relieving the distortion applied to the base substrate after forming the pattern portion.

10. The method according to claim 6, wherein
the acquiring a surface state includes:
acquiring maximum height of a convex portion present in the substrate from the surface state, and
the forming the pattern portion includes:
making thickness of the pattern portion larger than or equal to the maximum height.

11. The method according to claim 10, wherein the convex portion is foreign matter attached to the substrate.

12. The method according to claim 5, wherein
the acquiring a surface state includes:
acquiring height of a convex portion present in the substrate from the surface state, and
the forming the pattern portion includes:
forming the concave-convex pattern using a master pattern including a convex-shaped pattern matched with the height of the convex portion.

13. The method according to claim 5, wherein the acquiring a surface state includes:
measuring the surface state.

14. A template manufacturing apparatus comprising:
an acquisition section configured to acquire a surface state of a substrate to which a shape of a concave-convex pattern in a pattern portion of a template is to be transferred;
a calculation section configured to calculate a correction amount for the concave-convex pattern from the surface state acquired by the acquisition section; and
a formation section configured to form the pattern portion on a base substrate with the concave-convex pattern formed with correction by the correction amount calculated by the calculation section.

15. The apparatus according to claim 14, wherein the acquisition section includes an input section configured to input the surface state from outside.

16. The apparatus according to claim 14, wherein the acquisition section includes a measurement section configured to measure the surface state.
